(19) United States
(12) Patent Application Publication
(10) Pub. No.: US 2003/0218599 A1
(43) Pub. Date: Nov. 27, 2003

(54) Computer keyboard arrangement

(76) Inventor: Kim Burke, Oceanside, NY (US)

Correspondence Address: Kim Burke, 129 Davison Avenue, Oceanside, NY, 11572, US

(21) Appl. No.: 10/091,692

(22) Filed: Mar. 6, 2002

(51) Int. Cl. G09G 5/00

(52) U.S. Cl. 345/168

(57) ABSTRACT

An improved computer keyboard arrangement functions to allow a user to conveniently type graphic symbols. In a first embodiment, the arrangement comprises a traditional computer keyboard enhanced to include at least one additional row of keys that bear graphic symbols thereupon for typing said symbols, said symbols appearing upon a computer monitor. In a second embodiment, an improved computer keyboard arrangement functions to allow a user to conveniently type graphic symbols, the arrangement comprising a traditional computer keyboard; and an auxiliary keyboard removably affixed to the traditional keyboard. The auxiliary keyboard includes at least one row of keys that bear graphic symbols thereupon for typing said symbols, said symbols appearing upon a computer monitor. In all embodiments, typed graphic symbols represent previously determined words and phrases to facilitate on-line communications in an interactive global computer network.

This Application is a continuance of the Application entitled “Computer Keyboard Arrangement” filed by the present Applicant on May 20, 2000, with Ser. No. 09/460,508.

### BACKGROUND OF THE INVENTION

1. Field of the Invention

The present invention is a unique computer keyboard arrangement. More specifically, the present invention is a modified pre-existing keyboard or auxiliary keyboard that allows a user to conveniently type symbols or graphic images, which is of particular interest to those participating in on-line communications where “shorthand” style symbols are frequently utilized.

2. Description of the Prior Art

Numerous innovations for keyboard devices have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

U.S. Pat. No. 4,400,593, Invented by Kunz, Titled “Key Array”

The patent to Kunz describes a key array in which, progressing from key to key, the switching functions are derived by an AND-operation from mechanical signals indicating the actuation of pairs of adjacent keys of a row of keys or indicating the actuation of at least two diagonally opposite keys of a square group of four keys arranged in a rectangular keyboard. The pairs of adjacent keys and the square groups of four keys each are allocated to a single symbol and each are depressable simultaneously by the operator in order to initiate the single respective switching function. Thereby, a large surface lying in one single plane and being divided by gaps between the keys, is available for the symbol legend and for engagement by the fingertip.

U.S. Pat. No. 5,317,671, Invented by Baker, et. al., Titled “System for Method for Producing Synthetic Plural Word Messages”

In the patent to Baker, a linguistic coding system and keyboard for the use of people unable to use their voices is described. The coding system and keyboard are based on the sentence rather than the word or letter. The keyboard is coupled to a computer which stores plural word messages or sentences in memory for selective retrieval by the keyboard. The sentences retrieved from the keyboard are fed to a voice synthesizer which converts them through a loud speaker to audible spoken messages. The keyboard utilizes symbols on the respective keys and by designating a selected one of the keys and its associated polysemic symbols a primary message theme key, selected recorded plural messages in the computer memory may be retrieved by actuating a combination of the designated primary message theme key and other keys to vary the context of the polysemic symbols. Thus sentences associated with a central theme may be generated as a function of each symbol in combination with other symbols which modify the theme of the message or sentence.

U.S. Pat. No. 5,186,555, Invented by Chiba, Titled “Key Arrangement for Word Processor or the Like Electrode Instrument or Machine”

In the patent to Chiba, a keyboard for use in a workprocessor or like machine includes multiple keys arranged in an array of rows and columns, a stationary base, a moveable operator connecting each key and the base such that each is moveable in four diagonal directions relative to the remaining keys, and spring strips and switch contacts beneath each key and arranged such that movement of the key in any of the four diagonal directions closes a switch contact to produce a distinct function, such as an alphanumeric character.

U.S. Pat. No. 4,940,346, Invented by Liljenquist, Titled “Keyboard Assembly and Typing Method”

The patent to Liljenquist illustrates a keyboard assembly and method for typing for use with a device such as a word processor. Generally, the keyboard assembly comprises mutually adjacent keys, each covered by a visual pattern formed from a combination of shape and coloring. The pattern on each key is different from the pattern on each adjacent key in order to facilitate visual discrimination between keys. However, the patterns on keys in the same rows or columns share at least one distinctive design feature in order to assist the operator in properly orienting her hands over the keyboard. To further enhance both key discrimination and orientation over the keyboard, keys on every other row have different surface textures to provide distinctive tactile signals to the operator whenever the different-textured keys are touched. Finally, the keyboard assembly may include a document positioner located above the keyboard so that the operator may see the visual patterns on the keys when looking at a document being copied. In the typing method of the invention, the visual pattern associated with each symbol typed is simultaneously displayed in order to reinforce the association of the symbol and the pattern in the mind of the operator. The improved keyboard assembly greatly expedites the learning of typing skills and reading skills by associating a distinct visual pattern with each letter of the alphabet in the mind of the operator.

U.S. Pat. No. 5,920,303, Invented by Baker, et. al., Titled “Dynamic Keyboard and Method for Dynamically Redefining Keys on a Keyboard”

In the patent to Baker, a dynamic keyboard includes keys, each with an associated symbol, which are dynamically redefinable to provide access to higher level keyboards. Based on sequenced symbols of keys activated, certain dynamic categories and subcategories can be accessed and keys corresponding to them dynamically redefined. Dynamically redefined keys can include embellished symbols and/or newly displayed symbols. These dynamically redefined keys can then provide the user with the ability to easily access both core and fringe vocabulary words in a speech synthesis system.

U.S. Pat. No. 5,847,697, Invented by Sugimoto, Titled “Single-Handed Keyboard Having Keys with Multiple Characters and Character Ambiguity Resolution Logic”

The patent to Sugimoto describes a character generator for a keyboard where the keyboard has keys for entry of characters. Each key is assigned a character and some of the keys are multiple-character keys assigned multiple characters. The character generator includes a generator for generating one of the characters assigned to each of a sequence of character keys that are entered on the keyboard, with ambiguity as to the correct character to be generated when any multiple-character key is entered in the sequence. An ambiguity resolver operates in response to the sequence of character keys that have been entered for resolving the correct character for any of the multiple-character keys in the sequence of keys that are entered.

U.S. Pat. No. 5,576,706, Invented by Daigle, et. al., Titled “Methods and Apparatus for Using Multiple Keyboards Connected in a Daisy chain to a Keyboard Port of a Computer”

The patent to Daigle describes a system where multiple keyboards are connected in a daisy chain fashion to a computer using only the keyboard port of the computer. The keyboard system has an input connector and an output connector, wherein a child keyboard system that includes a plurality of keys corresponding to characters is connected to the input connector and one of a computer, and a parent keyboard system that includes keys corresponding to characters is connected to the output connector.

U.S. Pat. No. 5,387,042, Invented by Brown, Titled “Multilingual Keyboard System”

The patent to Brown describes a multilingual keyboard system including a customized keyboard unit provided to operate in conjunction with a central processing unit and a logic system having unique software in order to facilitate multilingual typing from a single keyboard. The keyboard includes customized keys which are shaped to receive label panels on one of several selectable templates. Each template corresponds to a particular character set which the user desires to utilize as an alternate character set to that appearing on the key labels. The keyboard also includes a toggle key for toggling between a standard mode of operation and the selected alternate mode. The logic system includes software having keymapping schemes associated with each selectable alternate mode. Changing templates permits usage of multiple alternate modes with the same equipment.

U.S. Pat. No. 4,124,843, Invented by Bramson, et. al., Titled “Multi-Lingual Input Keyboard and Display”

The patent to Bramson describes a data entry device with a keyboard for use with a data processing system. A first data set of input keys are arranged in a standard typewriter configuration. A second set of keys comprises additional rows of data input keys that enable the operator to enter various special characters or symbols that are encountered in different languages. One row of keys in the first set constitutes a variable row. A legend corresponding to a selectable set of symbols is juxtaposed to the variable row. An operator can select a set of characters so that each input key in the variable row thereafter functions to identify the character designated in a corresponding position of the juxtaposed legend.

U.S. Pat. No. 4,633,227, Invented by Menn, Titled “Programmable Keyboard for a Typewriter or Similar Article”

The patent to Menn describes a programmable keyboard apparatus for allowing a user to select a number of different keyboard arrangements such as the Qwerty or the Dvorak arrangements. The keyboard contains fixed input keys arranged in rows and columns and according to a standard typewriter keyboard format. Each key has an indicating area where the designation or symbol for the key is automatically changed by the apparatus each time a different format is selected. In this manner, the user can experiment with keyboard formats which enable more rapid typing with fewer errors. The construction is extremely economical, and therefore, a user will have access to different keyboard arrangements which will increase the user's ability to type. The keyboard disclosed can be used as a computer keyboard which will also enable a rapid change of symbols while permitting the operator to view the symbols for each different format through the respective windows.

As outlined above, the prior art patents that relate to improved computer keyboards largely entail elements such as: a way to simultaneously depress four keys to type a less-common symbol; a way to type a common short sentence with just one key, intended for disabled persons; colored-coated keys for quick identification by young children; a means to re-program the order of keys on a keyboard to arrive at a customized arrangement for individual comfort; multiple keyboards attached to one another and plugged into the same computer port, to create “parent” and “child” keypads; and several keypad inventions relating to changing characters for the ability to type in a foreign language.

In contrast to the above, the present invention is a keyboard that allows a user to conveniently type symbols that are particularly useful for those participating in on-line chat rooms. In the preferred mode, a keyboard is enhanced to include an additional row or column of keys that bear a selection of graphic symbols taken from a wide variety, for increased overall communications.

SUMMARY OF THE INVENTION

As noted above, the present invention is a unique computer keyboard arrangement. More specifically, the present invention is a keyboard that allows a user to conveniently type symbols or graphic images, which is of particular interest to those participating in on-line communications where “shorthand” style symbols are frequently utilized.

In the preferred mode of production, a traditional keyboard is enhanced to include an additional row or rows of keys that bear symbols for typing. For the purposes of example, a key bearing “:)” may be included to indicate a smile or general happiness. The enhanced keyboard may include a great variety of symbols, which may be grouped and geared towards particular computer users, such as a symbol-bearing keyboard for children, or a symbol-bearing keyboard for mature adults.

In an alternate embodiment, the concept of the present invention may be embodied in a second, auxiliary-type keyboard, which is added to a traditional keyboard to allow for convenient typing of graphic symbols. In any such case, the present invention allows for facilitated communication amongst computer users in Internet chat rooms, inter-office messages, and various other environments.

The novel features which are considered characteristic for the invention are set forth in the appended claims. The invention itself, however, both as to its construction and its method of operation, together with additional objects and advantages thereof, will be best understood from the following description of the embodiments when read and understood in connection with accompanying drawings.

### BRIEF DESCRIPTION OF PREFERRED EMBODIMENTS

FIG. 1 is a front perspective view of the computer keyboard arrangement of the present invention, illustrating traditional keyboard interfacing with auxiliary keyboard containing previously determined quantity of keys bearing graphic symbols, for the purposes of example.

FIG. 2 is a front perspective, cut-away view of a column of keys of either a modified keyboard or auxiliary keyboard bearing graphic symbols, such FIGURE intended to represent the overall style and appearance of the device of the present invention.

### DETAILED DESCRIPTION OF THE PREFERRED EMBODIMENT

The following description refers to both FIG. 1, which is a front perspective view of the computer keyboard arrangement of the present invention, illustrating traditional keyboard interfacing with auxiliary keyboard containing previously determined quantity of keys bearing graphic symbols, for the purposes of example, and FIG. 2, which is a front perspective, cut-away view of a column of keys of either a modified keyboard or auxiliary keyboard bearing graphic symbols, such FIGURE intended to represent the overall style and appearance of the device of the present invention.

In accordance with the present invention, an improved computer keyboard arrangement functions to allow a user to conveniently type graphic symbols, instead of only traditional letters, numbers, or punctuation marks. In one embodiment, the arrangement comprises a traditional computer keyboard which is enhanced to include at least one additional row of keys that bear graphic symbols thereupon for typing said symbols, said symbols appearing upon a computer monitor. As such, the specialized additional row may be vertical or horizontal in nature, and may be added to the traditional keyboard at a position above, below, to the left, or to the right of all previously existing traditional rows and columns.

In a second embodiment, an improved computer keyboard arrangement also functions to allow a user to conveniently type graphic symbols. This arrangement comprises a traditional computer keyboard and a second, or auxiliary keyboard which is removably affixed to the traditional keyboard. The auxiliary keyboard includes at least one row of keys that bear graphic symbols thereupon for typing said symbols, said symbols appearing upon a computer monitor. Importantly, the auxiliary keyboard may be retrofitted to previously existing keyboards so that all computer users can enjoy the benefits of the enhanced graphic symbol configuration.

In all embodiments, the typed graphic symbols represent previously determined words and phrases, functioning as a shorthand style of communication. Thus, the primary objective of the assembly is to facilitate on-line communications in an interactive global computer network. Because such an environment is fast-moving and dynamic in nature, the present invention will greatly appeal to those regularly interacting with others in such a forum, offering detailed and expressive forms of communication in the most efficient means possible.

For the purposes of example only, such graphic symbols may be any of the following: many different facial expressions; men, women, boys, girls, or infants engaged in a variety of acts or activities; animals; fictional characters; food or drink items; trees and flowers; tools or equipment; vehicles; toys; sporting goods items; clothing items; furniture items; items relating to nature, space, or the environment; graphics found on common signs; and many other forms of visual data to represent the thoughts or feelings of the computer user in question.

In order to tailor the graphic symbol keys towards the interests of particular users, the improved keyboard may include at least one row of graphic symbols grouped together and relating to one another according to a previously determined theme. Thus, if a user finds herself in need of a particular style of communication on a regular basis, due to regular subject matter or language, said user may obtain an enhanced keyboard featuring keys consistent with her interests prominently.

Furthermore, regarding tailoring specified keyboards according to the present invention to particular groups of users, the improved keyboard may also include at least one row of graphic symbols readily identifiable by children, and particularly geared towards youths. In order to make the keyboard even more attractive to children, the keyboard may bear a variety of indicia thereon and may be multi-colored in appearance.

Conversely, in accordance with the versatility of the present invention, the improved keyboard may include at least one row of graphic symbols intended for mature adults only. Such an enhanced keyboard is expected to function in a manner that would allow adults to freely communicate in an expressive and mature manner that is both convenient and entertaining.

Moreover, also adding to the versatility of the invention is that the keyboard may be manufactured in such a manner as to allow a user to interchange keys bearing the graphic symbols, which will function to allow the user to place those keys used most commonly in convenient positions for typing. Similarly, the keys may bear removable identifying labels thereupon, with the labels also interchangeable to allow the user to place keys used most commonly in convenient positions for typing.

Finally, it should be noted that the improved keyboard of the present invention functions to allow for facilitated communication among computer users in not only global computer network chat rooms, but local area network forums, and inter-office messages. Such can be expected to greatly enhance the overall appeal and value of the invention, as virtually any group of computer users can enjoy the benefits of the invention.

With regards to all FIGURES, while the invention has been illustrated and described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

Without further analysis, the foregoing will so fully reveal the gist of the present invention that others can readily adapt it for various applications without omitting features that, from the standpoint of prior art, constitute essential characteristics of the generic or specific aspects of this invention. What is claimed as new and desired to be protected by Letters Patent is set forth in the appended claims.

What is claimed is:

1. An improved computer keyboard arrangement, which functions to allow a user to conveniently type graphic symbols, the arrangement comprising: a traditional computer keyboard enhanced to include at least one additional horizontal row of keys across a top portion thereof that bears said graphic symbols thereupon for typing said graphic symbols,
said graphic symbols appearing upon a computer monitor linked to the device, said graphic symbols represent previously determined words and phrases to facilitate on-line communications in an interactive global computer network, the keyboard manufactured in such a manner as to allow a user to interchange keys bearing graphic symbols, functioning to allow the user to place keys used most commonly in convenient positions for typing,
the keys further bearing removable identifying labels thereupon, said labels interchangeable in nature to allow the user to place said labels upon keys with previously assigned graphic symbols used most commonly in convenient positions for typing,
the improved keyboard comprising at least one row of said graphic symbols grouped together and relating to a previously determined theme, the improved keyboard bearing indicia thereon and generally multi-colored in appearance,
the graphic symbols selected from the group consisting of facial expressions, men, women, boys, girls, and infants engaged in multiple previously determined activities, animals, fictional characters, food and drink items, trees and flowers, tools and equipment, vehicles, toys, sporting goods items, clothing items, furniture items, items relating to nature, space, and the environment, used to represent thoughts and feelings of the user, the improved keyboard functioning to allow for facilitated communication among computer users in global computer network chat rooms, local area network forums, and inter-office messages.

2. The improved computer keyboard arrangement as described in claim 1, wherein the improved keyboard includes at least one row of said graphic symbols readily identifiable by children.

3. The improved computer keyboard arrangement as described in claim 1, wherein the improved keyboard includes at least one row of graphic symbols intended for mature adults only.

4. An improved computer keyboard arrangement, which functions to allow a user to conveniently type graphic symbols, the arrangement comprising: a traditional computer keyboard; and an auxiliary keyboard removably affixed to the traditional keyboard, and retrofitted to previously existing keyboards, the auxiliary keyboard including at least one row of keys that bear graphic symbols thereupon for typing said symbols, said symbols appearing upon a computer monitor, the auxiliary keyboard manufactured in such a manner as to allow a user to interchange keys bearing graphic symbols, functioning to allow the user to place keys used most commonly in convenient positions for typing, the auxiliary keyboard keys further bearing removable identifying labels thereupon, said labels interchangeable in nature to allow the user to place keys used most commonly in convenient positions for typing, the keyboard bearing indicia thereon and generally multi-colored in appearance.
